(19) United States
(12) Patent Application Publication
(10) Pub. No.: US 2006/0237066 A1
(43) Pub. Date: Oct. 26, 2006

(54) Versatile valve

(76) Inventors: Michael C. Gagne, Chatsworth, CA (US); Dean C. Richards, Chatsworth, CA (US); Joseph Peter Marcilese, Chatsworth, CA (US)

Correspondence Address: Maria Erlinda C. Sarno, Esq., P.O. Box 1023, Artesia, CA, 90702, US

(21) Appl. No.: 11/113,475

(22) Filed: Apr. 25, 2005

(51) Int. Cl. F16K 27/00

(52) U.S. Cl. 137/551

(57) ABSTRACT

A valve comprising a bonnet, an actuator for controlling the movement of a diaphragm situated between the bonnet and a valve body having an inlet port, an outlet port, a passageway connecting the inlet port and the outlet port for fluid flow, the valve body having an access receiving port for accommodating a device. The access receiving port is designed to accommodate any type of devices especially a test instrument which is usually a measuring or a sensing device. The access receiving port may be one or more than one. The proposed valve body can replace an existing valve body thereby avoiding the need to replace the entire valve. The access receiving port can have the same design or different designs. It is located either above the passageway of the valve body for a weir type valve or into the passageway of the valve body for a radial style valve.

This invention relates to valves having an access receiving port for devices and instrumentations within a valve body.

### BACKGROUND

There is an ongoing desire in the industry, especially those that process costly products or products found only in limited quantity, to maximize product recovery and minimize product loss. Losses may come from physical or chemical causes. The claimed invention deals with physical loss of product along the process system, most likely due to product retention at the piping, interconnections or equipment used for processing. This is being addressed by minimizing dead legs throughout the process system. Dead legs are areas where fluid may become trapped or held up within the process system such as product retention on the pipes due to inadequate drainage, pockets usually caused by sharp turns in the interconnection of parts, and poor design of the devices and equipment used in the process. This invention focus on minimizing product loss due to the attachments of devices and instrumentations, herein collectively referred to as devices, used for monitoring process conditions such as testing along the process system, more specifically on systems using the weir type or radial style valves. There are a number of improvements made on minimizing dead legs in the use of these type of valves for processing. Most of these deal with providing multiple output ports from a single inlet port to minimize product loss or hold up experienced with the use of multiple valves. With a single valve having multiple ports, one minimizes the potential product loss at the connectors, especially the tee connectors, required to join several valves and at the internal chambers of each additional valve used within the system. Examples of these types of valves are described in U.S. Pat. No. 5,906,223 which proposes an entire valve assembly machined out of a single block of material having smooth liquid pathways and shared fully flushable flow compartments and U.S. Pat. No. 5,273,075 proposing a diaphragm valve having a single inlet port and two outlet ports in which the flow of fluids can be directed from the inlet port to one or the other outlet ports. Most measuring or sensing devices, also herein interchangeably referred to collectively as test instruments, are placed either before the valve or after the valve because of the increased number of locations where a testing instrument can be placed. Further, testing proximal to the valve is preferred because of the ability of these valves to stop, reduce, increase or maintain the flow of fluid according to the conditions required by the test method or by the test instrument. These devices are usually connected by clamping or joining together, the connector for the device and the connector at the inlet or outlet port of the valve. The connector on the devices are herein referred to as access port to differentiate this from the connector port at the inlet and outlet of a valve. The connector on the valve body which will be described later is referred to as access receiving port to differentiate this from the access port on the device. While dead leg has been minimized by reducing the number of valves, it should not be ignored that potential product hold up occurs at every joint or connection between the device and the valve. When one considers the number of parameters that are tested during production and the number of times they are monitored, the potential product hold up becomes sizeable. To minimize this, it is proposed to introduce these devices into the valve body as opposed to connecting these at the inlet or outlet ports of the valve. Some patents, U.S. Pat. Nos. 6,374,679; 6,591,684; and 6,736,013 issued to Babala, et al. pertains to a pressure sensor mounted integrally in a hydraulic valve body. Because of the broad coverage of the word valve, the valve body in Babala should not be mistaken for the valve body of a weir type or radial style valve. Babala's valve body includes solenoid valves connected to a vehicle hydraulic brake system which differs from the weir type and radial style valves which controls fluid passage through a pipe/s. Also, Babala did not have minimization of fluid as a purpose and there is no teaching if it did on his system which is related to pressure sensors for an anti-lock brake system of a vehicle. Further, the pressure sensor of Babala once mounted, stays permanently on the valve body. In contrast, the devices such as the test instruments here can be replaced, substituted, removed and reinstalled to the valve body as desired.

It is therefore an object of this invention to reduce product loss caused by physical retention of products at the joint between the valve and the device.

It is also an object of this invention to provide a valve that includes an access receiving port for the test instrument and other devices within the valve body thereby minimizing the number of joints and valves in the process system.

It is a further object of this invention to provide a valve having a valve body with multiple variety of ports catered to connect with the different types of devices.

It is also a further object of this invention to provide a more accurate measurement of process parameters by allowing the measuring or sensing device to take measurements on the fluid within the valve body of a valve.

It is still a further object of this invention to allow removal and reinstallation of a device on an access receiving port of a valve.

It is still also a further object of this invention to cut the cost and space requirement for the process system by reducing the number of connectors, valves and pipes used by the process.

### SUMMARY OF THE INVENTION

This invention relates to a valve comprising a bonnet, an actuator for controlling the movement of a diaphragm situated between the bonnet and a valve body having an inlet port, an outlet port, a passageway connecting the inlet port and the outlet port for fluid flow, the valve body having an access receiving port located above or into the passageway of the valve body for accommodating a device. The access receiving port can be designed to accommodate any type of devices especially a test instrument which is usually a measuring or a sensing device. The access receiving port may be one or more than one. The number of access receiving ports depend upon the structural strength and performance expected from the valve. This can be easily determined on a case by case basis. To minimize the cost of adopting the proposed valves, the valve body with the access receiving port can replace a valve body without an access receiving port without the need to replace the entire valve. For greater flexibility, it is desirable to design devices with the same access port that would fit into the same or matching access receiving port on the valve body. An access port is connected to a device while an access receiving port is connected or is a matching opening on the valve body of the valve. The valve body, however, can have different types of access receiving ports to cater to the different size, shape, design, and method of attachment of a particular device. The access receiving port is located either above the passageway of the valve body for a weir type valve or into the passageway of the valve body for a radial style valve. An access receiving port that allows contact of a test instrument directly with a fluid inside the valve body can enable the test instrument to get more accurate test results. The access receiving port herein allow removal and replacement of the device. The access receiving port can be made of metal or non-metal or a combination of both.

Other embodiments of the present invention will become readily apparent to those skilled in the art from the following detailed description, wherein it shows and describes only certain embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWING

Aspects of the present invention are illustrated by way of example, and not by way of limitation, in the accompanying drawings, wherein:

FIG. 1 is an exploded isometric view of a weir type valve.

FIG. 1A is an isometric view of an assembled weir type valve.

FIG. 2 is an exploded isometric view of a radial style valve.

FIG. 2A is an isometric view of an assembled radial style valve.

FIG. 3 shows the current method of attaching a small test instrument proximal to a valve within a process system.

FIG. 4 shows the current method of attaching a large test instrument proximal to a valve within a process system.

FIG. 5 shows the current method of attaching devices and instruments in a multiple outlet port valve.

FIG. 6 is an isometric view of the proposed valve having an access receiving port at the valve body for a device.

FIG. 6A is an isometric view of FIG. 6 with a test instrument attached.

FIG. 7 is an isometric view of a valve body of a weir type valve having multiple access receiving ports for accommodating multiple devices.

FIG. 7A is an isometric view of a valve body of a radial style valve having multiple access receiving ports for accommodating multiple devices.

FIG. 8 is a cross sectional view of a valve body of a weir type valve having different types of access receiving ports for different types of test instruments.

FIG. 8A is a cross sectional view of a valve body of a radial style valve having different access receiving ports for different types of test instruments.

### DETAILED DESCRIPTION OF THE INVENTION

The detailed description represented herein is not intended to represent the only way or the only embodiment in which the claimed invention may be practiced. The description herein is provided merely as an example or examples or illustrations of the claimed invention and should not be construed as the only way or as preferred or advantageous over other embodiments or means of practicing the invention. Any means of incorporating a device directly into a valve body of a weir type or radial style valve used in controlling fluid flow through a pipe to reduce dead leg, thereby reducing product loss due to physical hold up or retention of product associated with the installation of devices along a process system is within the scope of this invention. The detailed description includes specific details to provide a thorough understanding of the claimed invention and it is apparent to those skilled in the art that the claimed invention may be practiced without these specific details.

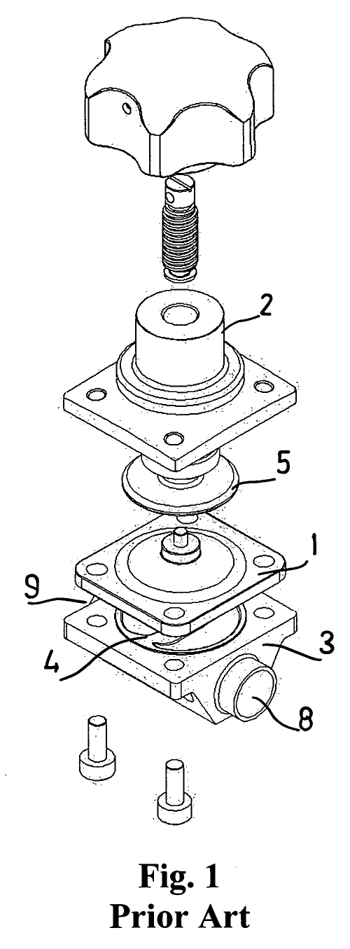

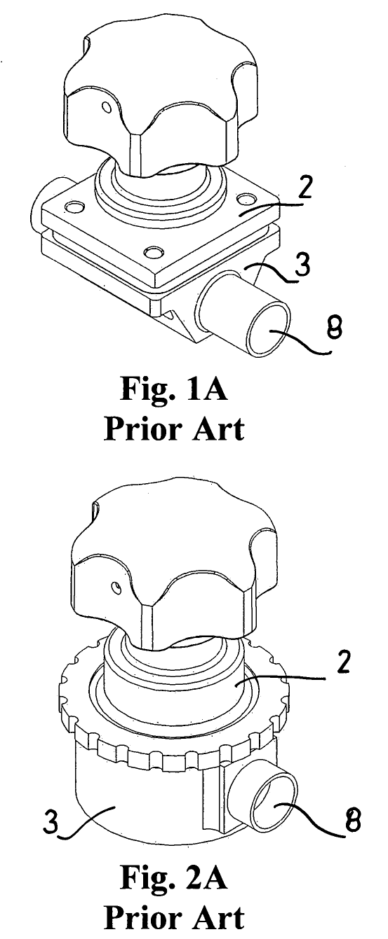

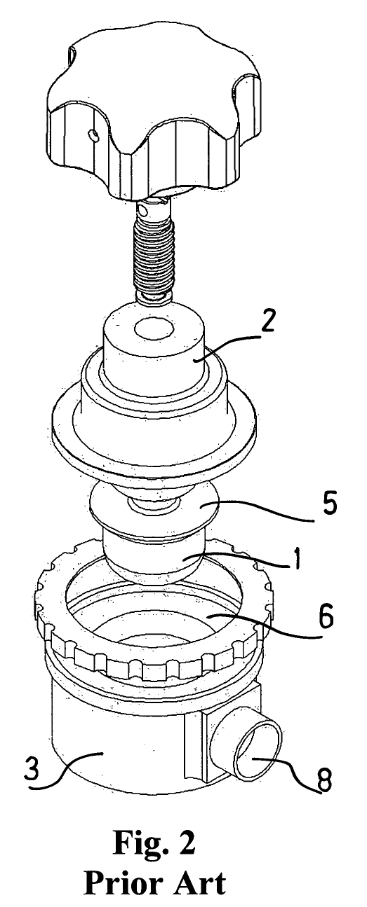

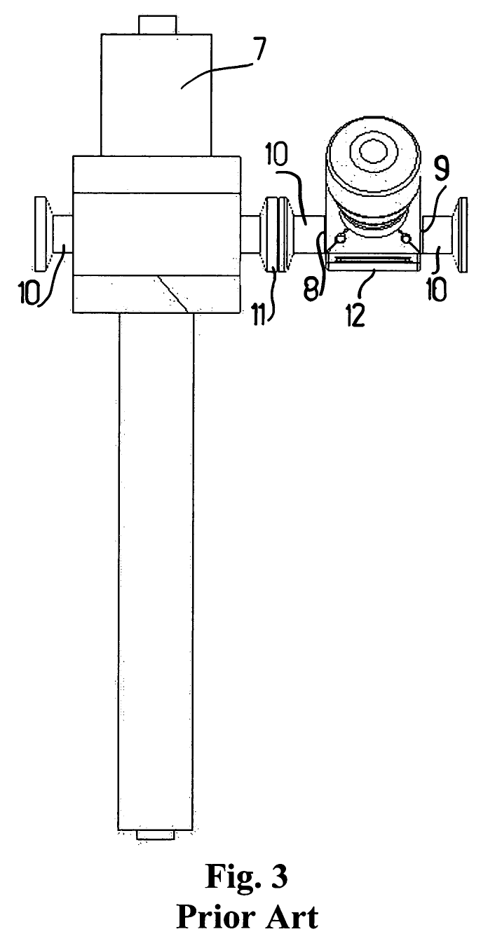

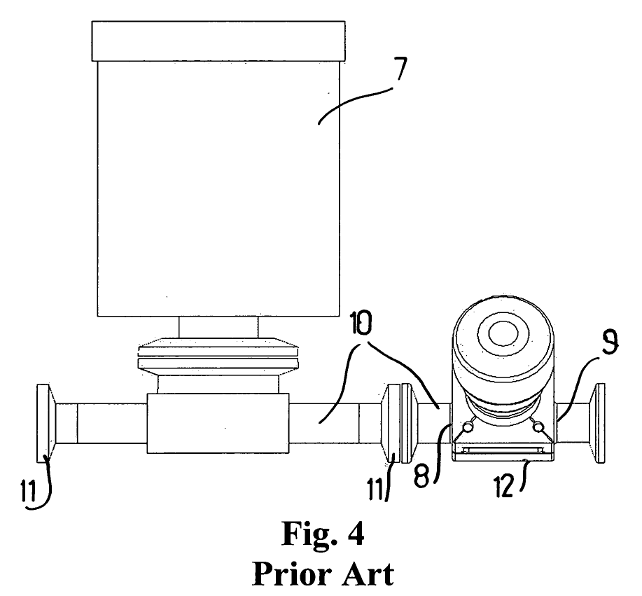

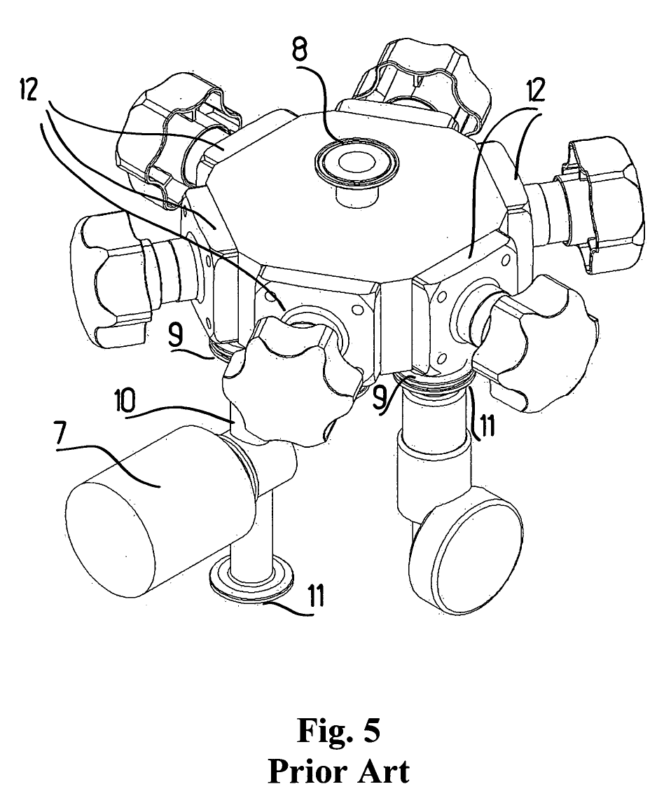

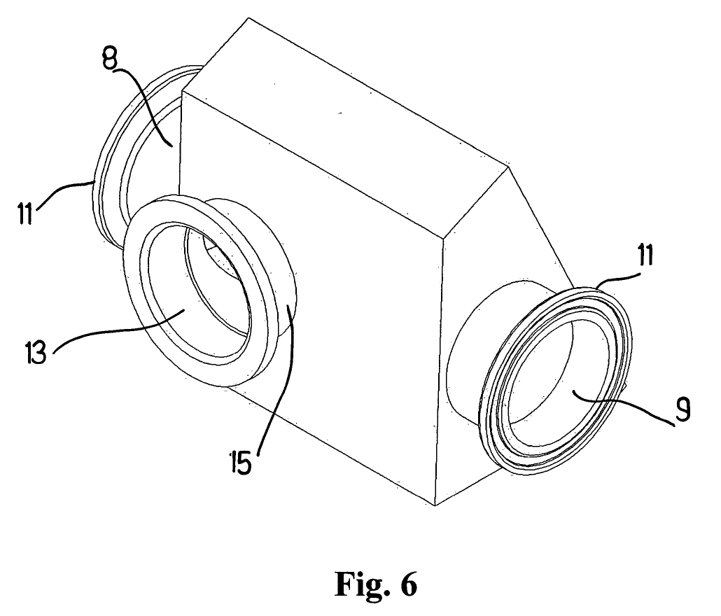

FIGS. 1 and 2 show the components of a weir type and radial style valve, respectively, while FIGS. 1A and 2A shows their corresponding assembled valves. Similar parts of the valves are given the same number. Both valves have a diaphragm 1 and their bonnets 2 are similar in structure. In the weir type valve as the name denotes, the valve has a weir 4 between the inlet 8 and the outlet 9 port of the valve body 3. Fluid flow is controlled by the diaphragm 1 completely pressing on the weir 4 to stop the flow or releasing from the weir to allow the flow. Intermediate flow rates are attained by the diaphragm slightly pressing on the weir. The movement of the diaphragm to or away from the weir is controlled by an actuator 5. In the radial style valve, the diaphragm 1 presses on a valve seat 6 to close the flow or disengages from the valve seat to allow the flow of fluid. Currently, a device such as a test instrument 7 is usually connected before a valve inlet 8 or after a valve outlet 9 as shown in FIG. 3. FIG. 5 shows how a multiple (only two are illustrated herein) of these test instruments 7 can connect to each inlet 8 and outlet port 9 of a valve 12. As shown, this results in additional piping 10 between the valve and the test instrument where product can potentially be retained even in a drainable process system because a certain amount of product tend to adhere on the inside surface of the pipes 10 and the connectors 11. Dead legs still exist, although minimized, by a valve having multiple outlet ports because each outlet port can directly connect to a test instrument instead of having a whole valve between each inlet port and outlet port as shown in FIG. 5 where there is only one inlet port compared to FIGS. 3 and 4 where there is one inlet port for each outlet port. Further, the amount of dead leg also depend upon the size of the test instrument. FIG. 3 shows a smaller test instrument such as a pH meter connected to a valve while FIG. 4 shows a larger test instrument like a temperature transmitter connected to a valve 12. More dead leg is expected from larger test instruments.

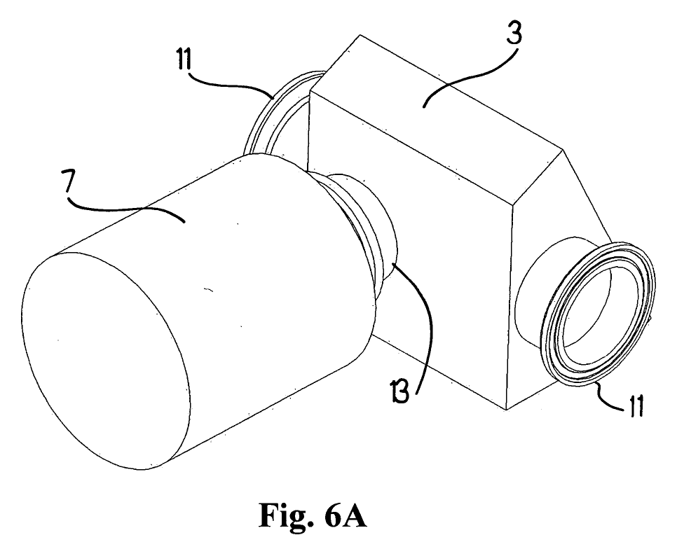

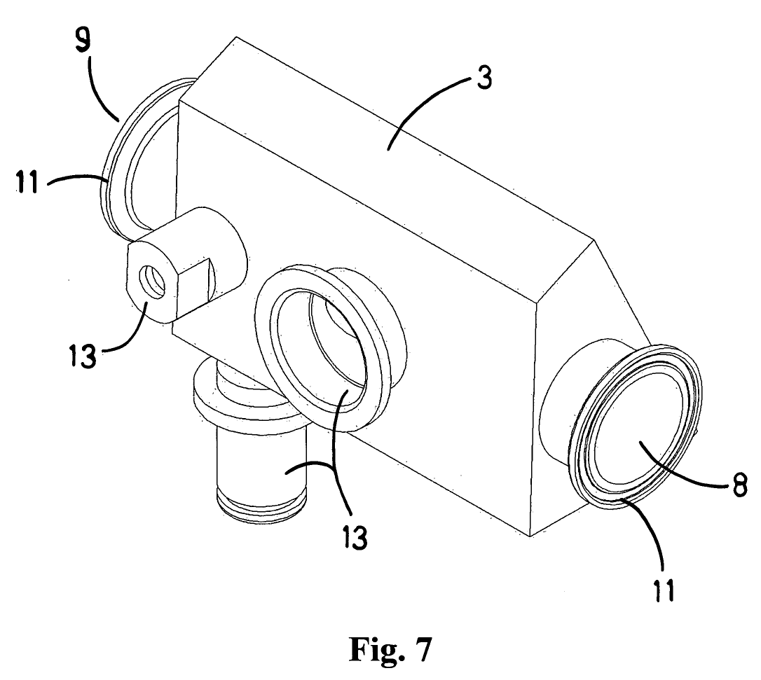

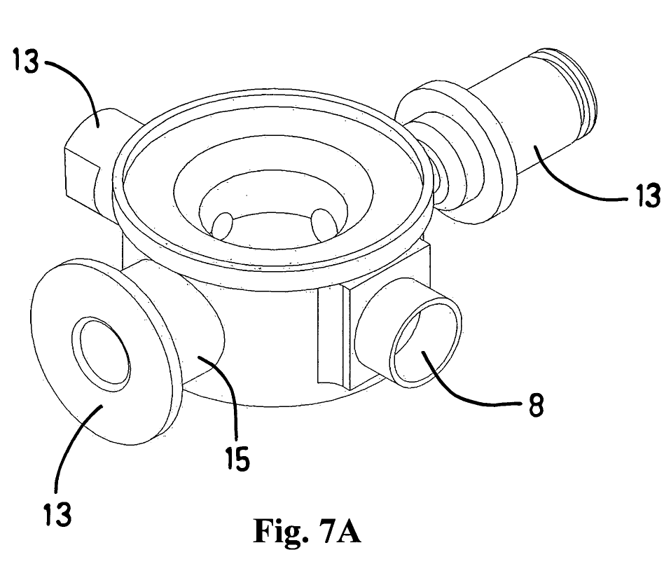

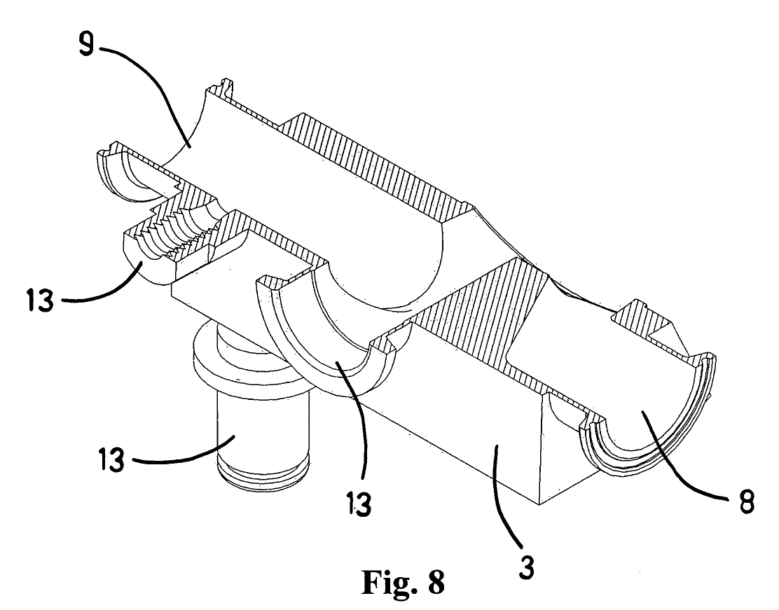

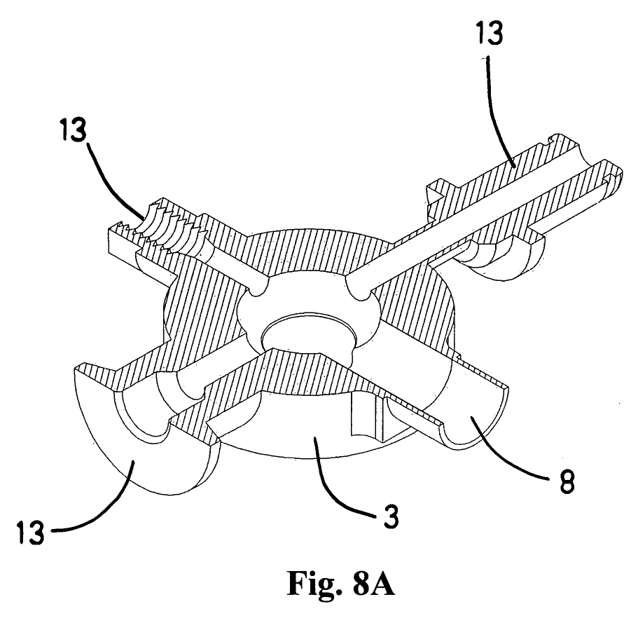

To minimize these dead legs, it is proposed to install devices such as these test instruments directly to the valve body 3 as shown in FIGS. 6, 7 and 8. FIG. 6 shows the valve body of a weir type valve having an access receiving port 13 without an attached device while FIG. 6A shows the valve body having a test instrument 7 connected to the valve body through an access receiving port 13. All devices and their examples are identified with the number 7. With this type of connection, dead legs due to the extra pipe 10, connector 11 and valve 12 needed to connect a device at the inlet 8 or the outlet port 9 of the valve are minimized. With the elimination of these extra piping, connectors and valves, one also realizes tremendous savings in the overall cost of the process system by reducing the number of valves, connectors and piping to connect one component with another as well as in the reduction of space requirement to house the process system which are also vital to a manufacturer. As shown in FIG. 6A, a test instrument 7 connects to an access receiving port 13 located at the valve body 3 and not at the connector port 11 of an inlet or outlet port of the valve body. Several of these access receiving ports 13 can be installed directly to the valve body without the need to alter the size of the diaphragm, weir or valve seat as shown in FIGS. 7 and 7A, therefore, one can use the existing valves replacing only the existing valve body with the new proposed valve body having the access receiving port/s. One merely lengthens the passageway 14 inside the valve body 3 to and from the weir 4 or enlarge the valve body 3 of the radial style valve as shown in FIGS. 7, 7A, 8 and 8A. The size, shape, number and method of attachment of the access receiving ports shown in FIGS. 7, 7A, 8 and 8A are merely illustrative and not comprehensive. The access receiving ports 13 can be designed to cater to a particular device 7. The number of access receiving ports will depend upon the structural strength and the performance expected from the valve and are located either above the passageway 14 of the valve body 3 for a weir type valve or into the passageway 14 of a radial style valve for those devices like the test instruments that require contact with the process fluid. Also, the length of the pipe 15 attached to the access port 13 can be minimized according to the requirements of the test instrument The valve and its components as well as the access receiving ports herein can be made or manufactured with metal or non-metal or a combination of both according to the discretion of the manufacturer or the user.

For test instruments, the access receiving port should allow direct contact of the instrument with the fluid inside the valve body. Attachment of the test instruments directly on the fluid present inside the valve body rather than at a distance from an inlet or outlet port of the valve, additionally provides an opportunity to get a more accurate result of the process parameters at different conditions such as when the fluid is static or when it is in a dynamic state. In a given process, there are usually several parameters that are tested such as pH, temperature, conductivity, turbidity, temperature transmission, pressure, dissolved oxygen, oxidation reduction potential, UV, visible and infrared absorption, etc. Devices with the same access port design would be able to exchange positions with each other within the valve body. For example one valve would connect a pH probe in one process and connects a thermometer for another process, if these two test instruments share the same type of access receiving port, that is, same size, shape and method of attachment. For clarity, the connecting port attached to the device is referred to as access port while the corresponding matching port in the valve body is referred to as access receiving port. For devices especially test instruments having their own unique access port, the access receiving ports of the valve body would cater to their individual designs. Being an access receiving port, it is also possible to close or cap any port that may not be needed for a particular process.

While the embodiments of the present invention have been described, it should be understood that various changes, adaptations, and modifications may be made therein without departing from the spirit of the invention and the scope of the claims.

We claim:

1. A valve comprising:
a bonnet, an actuator for controlling the movement of a diaphragm situated between the bonnet and a valve body having an inlet port, an outlet port, a passageway connecting the inlet port and the outlet port for fluid flow, the valve body having an access receiving port for accommodating a device.

2. The valve of claim 1 wherein the device is a test instrument, a measuring or a sensing device.

3. The valve of claim 1 wherein the access receiving port is more than one.

4. The valve of claim 3 wherein the number of access receiving port depend upon a structural strength and performance expected from the valve.

5. The valve of claim 1 wherein the valve body with the access receiving port can replace a valve body of an existing valve without an access receiving port.

6. The valve of claim 1 wherein the access receiving ports at the valve body are of the same type.

7. The valve of claim 1 wherein the access receiving ports at the valve body are of different types.

8. The valve of claim 7 wherein the access receiving ports at the valve body have differing size, shape, design, and method of attachment catering to each particular access port of the device.

9. The valve of claim 1 wherein the access receiving port is located above or into the passageway of the valve body.

10. The valve of claim 1 wherein the access receiving port is made of metal or non-metal or a combination of both.

11. The valve of claim 1 wherein the access receiving port allow contact of a test instrument directly with a fluid inside the valve body.

12. The valve of claim 1 wherein the access receiving port on the valve body allow removal and replacement of the device.

13. A valve comprising:
a bonnet, an actuator for controlling the movement of a diaphragm situated between the bonnet and a valve body having an inlet port, an outlet port, a passageway connecting the inlet port and the outlet port for fluid flow, the valve body having an access receiving port located above or into the passageway of the valve body for accommodating a device, the access receiving port having a design catering to an access port of the device.

14. A valve comprising:
a bonnet, an actuator for controlling the movement of a diaphragm situated between the bonnet and a valve body having an inlet port, an outlet port, a passageway connecting the inlet port and the outlet port for fluid flow, the valve body having an access receiving port located above or into the passageway of the valve body for accommodating a device having a matching access port, the access receiving port allowing removal and replacement of a device.
